(19) United States
(12) Patent Application Publication
(10) Pub. No.: US 2009/0193616 A1
(43) Pub. Date: Aug. 6, 2009

(54) Rolling Patio Furniture Covers

(76) Inventors: Jared Hendricks, Draper, UT (US); Erik Bornemeier, Bountiful, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/024,818

(22) Filed: Feb. 1, 2008

(51) Int. Cl. A47C 7/66; B60B 33/00; A47C 31/10; A47C 31/11; A47B 13/08

(52) U.S. Cl. 16/30; 108/161; 108/90; 297/229; 297/184.11; 150/154; 150/158

(57) ABSTRACT

Wheeled covers for patio furniture are described. The patio furniture covers include wheels attached to the covers that are positioned to secure to and support at least two locations on the covered patio furniture. When the patio furniture covers are used to cover the patio furniture, the covered patio furniture may then be easily wheeled using the cover wheels to move the covered patio furniture from one location to another. Thus, the patio furniture itself need not have wheels, and no modification of the patio furniture is required. The wheels of the patio furniture covers may be secured to the patio furniture to ensure stability of the wheeled configuration. The covers may include a self-contained or self-attached storage bag or pouch in which the patio furniture cover may be stored when not in use.

### BACKGROUND OF THE INVENTION

1. Field of the Invention

The present invention relates to patio furniture covers, and more particularly to patio furniture covers that provide for easy and convenient rolling of covered patio furniture.

2. Background and Related Art

Patio furniture is typically utilized outdoors and is thus manufactured so as to be able to withstand significant exposure to the elements (sun, cold temperatures, precipitation, wind, etc.). In some instances, however, it may be desirable to extend the life of the patio furniture by sheltering the patio furniture from exposure to the elements when not in use. As patio furniture is typically bulky and may additionally be heavy, and because it may be desirable to quickly transition the patio furniture back and forth from a sheltered state to a use state, remote storage of the patio furniture, such as in a storage room, is often less than feasible.

Because of this, patio furniture covers may be used to shelter patio furniture from the elements without requiring that the patio furniture be moved (or moved far) from its normal use location. FIGS. 1 and 2 illustrate the functions of existing patio furniture covers. These Figures show perspective views of a piece of patio furniture 10 covered by a patio furniture cover 12. The patio furniture cover 12 may be made of plastic, fabric, etc. as is well-known in the art, and may be custom-formed to fit a particular piece of patio furniture 10 or may be formed to approximately fit a number of pieces, brands, or shapes of patio furniture 10 within a certain subset of such furniture.

While such patio furniture covers 12 provide protection from the elements, they are limited in at least several regards. First, such patio furniture covers 12 provide essentially no additional functionality beyond protection from the elements. Second, such patio furniture covers 12 may actually hinder someone from moving the covered patio furniture 10 when needed, as the patio furniture covers 12 may make it difficult to see and determine where to hold the patio furniture 10 to move it, and also the added weight of the patio furniture cover 12 may make it more difficult to move the covered patio furniture 10.

### BRIEF SUMMARY OF THE INVENTION

Implementations of the present invention provide covers for patio furniture that require no modification of the patio furniture while simultaneously providing benefits over existing patio furniture covers. The patio furniture covers include wheels attached to the covers that are positioned to secure to and support at least two locations on the covered patio furniture. When the patio furniture covers are used to cover the patio furniture, the patio furniture may then be easily wheeled using the cover wheels to move the covered patio furniture from one location to another. Thus, the patio furniture itself need not have wheels, and no modification of the patio furniture is required.

Further implementations of the present invention permit the wheels of the patio furniture covers to be secured to the patio furniture to ensure stability of the wheeled configuration. Still further implementations of the present invention provide a self-contained or self-attached storage bag in which the patio furniture cover may be stored when not in use.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a perspective view of an existing patio furniture cover located on a piece of patio furniture, wherein the patio furniture cover is illustrated as being semi-transparent;

FIG. 2 shows an alternate perspective view of the existing patio furniture cover, wherein the patio furniture cover is illustrated as being semi-transparent;

FIG. 3 shows a perspective view of a patio furniture cover in accordance with embodiments of the present invention, wherein the patio furniture cover is illustrated as being semi-transparent;

FIG. 4 shows an alternate perspective view of the patio furniture cover of FIG. 3, wherein the patio furniture cover is illustrated as being semi-transparent;

FIG. 5 shows a front plan view of a wheel assembly in accordance with embodiments of the present invention;

FIG. 6 shows a side plan view of the wheel assembly of FIG. 5; and

FIG. 7 shows a perspective view of the wheel assembly of FIGS. 5 and 6.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the present invention provide covers for patio furniture that require no modification of the patio furniture while simultaneously providing for benefits over existing patio furniture covers. The patio furniture covers include wheels attached to the covers that are positioned to secure to and support at least two locations on the covered patio furniture. When the patio furniture covers are used to cover the patio furniture, the patio furniture may then be easily wheeled using the cover wheels to move the covered patio furniture from one location to another. Thus, the patio furniture itself need not have wheels, and no modification of the patio furniture is required.

Further embodiments of the invention permit the wheels of the patio furniture covers to be secured to the patio furniture to ensure stability of the wheeled configuration. Still further embodiments of the present invention provide a self-contained or self-attached storage bag in which the patio furniture cover may be stored when not in use.

In the Figures, a representative piece of patio furniture 10, namely a lounge chair, is illustrated in stylized form by way of example only. Embodiments of the present invention may be used with other types of patio furniture and may also be used with any other type of portable or semi-portable furniture or equipment having a cover or where a cover is desirable. Examples of such furniture, patio furniture, and equipment include chairs, stacked chairs, lounge chairs, tables, benches, stools, outdoor grills, standalone bars, rocker chairs, gliders, standalone porch swings, love seats, couches, sectional sofas, chaises, chaise lounges, ottomans, umbrella stands, hammock stands, table/bench combinations, and any other similar furniture and equipment having legs to engage with the covers as described herein. Therefore, in the description and in the claims, the term “patio furniture” shall embrace and mean any such furniture or equipment.

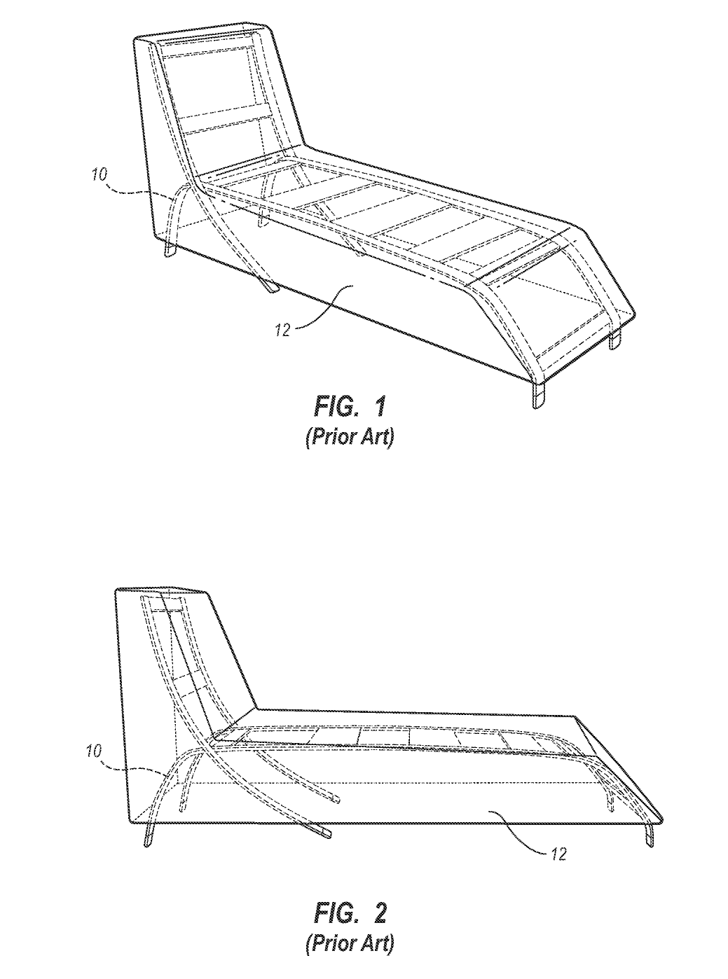

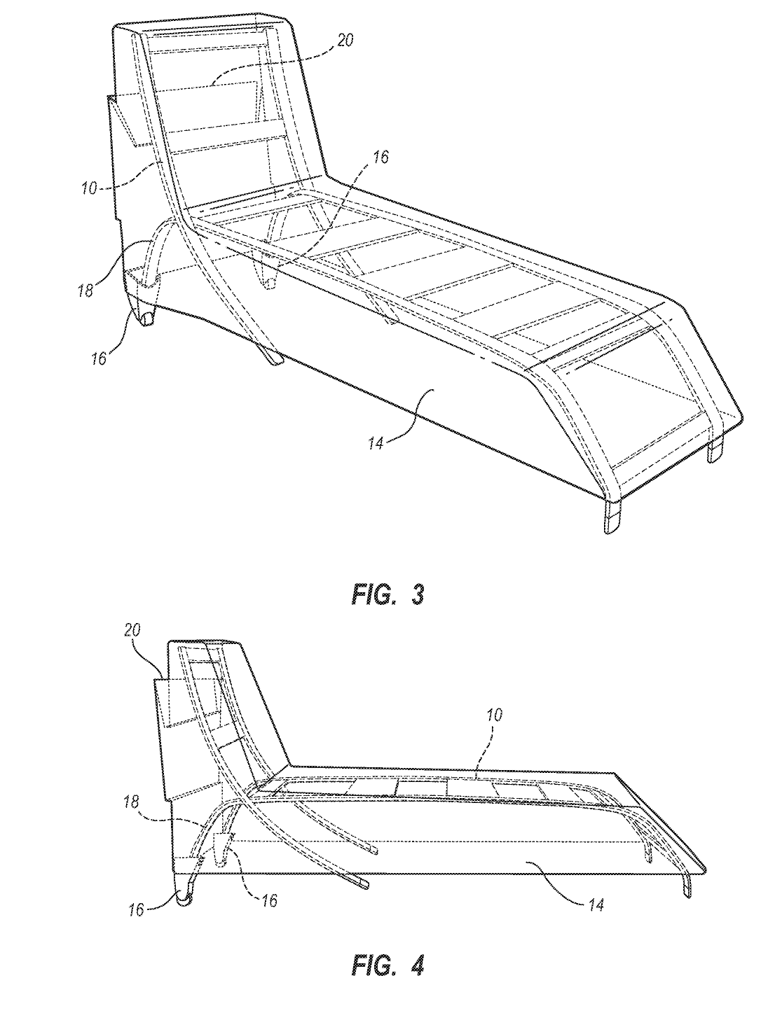

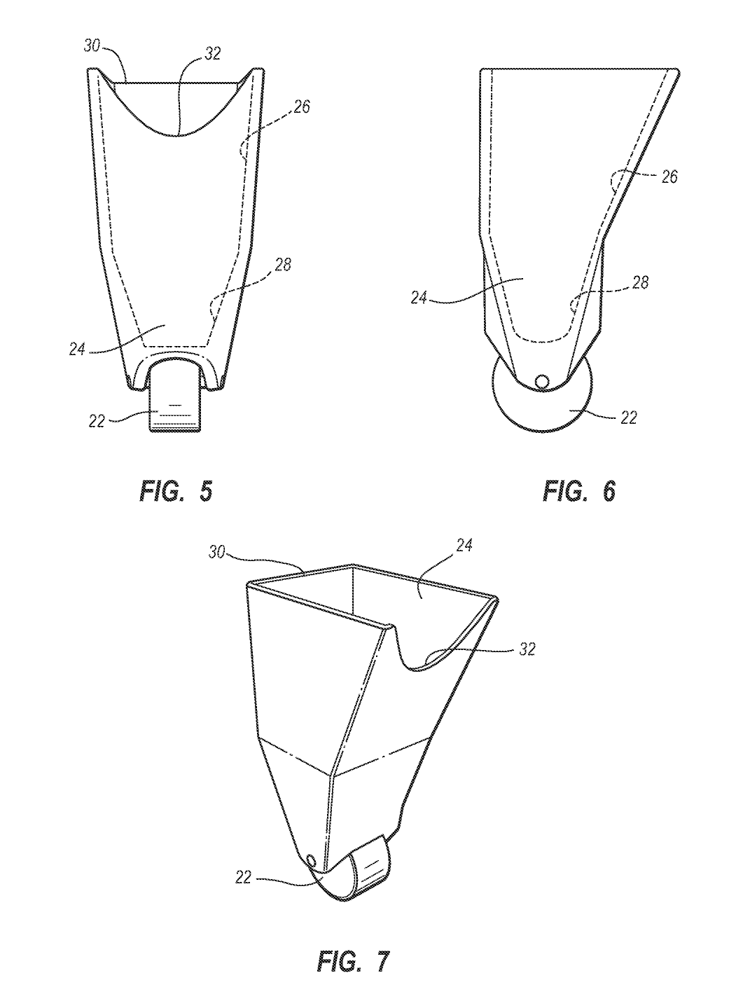

It is anticipated that those of skill in the art will understand how the embodiments described below may be adapted for utilization with any type of patio furniture. The patio furniture 10 illustrated in FIGS. 3-4 is substantially similar to the patio furniture 10 illustrated in FIGS. 1-2, which illustrates that utilization of the embodiments of the present invention requires no modifications to existing patio furniture. FIGS. 3-4 also illustrate a cover 14 that is different from the existing patio furniture covers 12, such as the one illustrated in FIGS. 1-2. The cover 14 includes a pair of wheel assemblies 16. The wheel assemblies 16, as illustrated more fully in FIGS. 5-7, are hollow and receive the distal free ends of a pair of legs 18 of the patio furniture 10 when the patio furniture 10 is being covered by the cover 14.

The wheel assemblies 16 are secured to the material of the cover 14 by any means known in the art. By way of example, the wheel assemblies 16 may be secured to the material of the cover by rivets, by an adhesive, by sewing/stitching, by staples, or by any other attachment means currently known in the art or later invented that provides a secure connection between the cover 14 and the wheel assemblies 16. In some instances, the material of the cover 14 may be reinforced to prevent tearing or other failure of the material during use, as will be appreciated by those skilled in the art. The cover 14 may be made of plastic material, cloth or fabric materials, such as canvas, or any other cover material currently known in the art.

Generally speaking, the material for the cover 14 may have some elasticity to permit some stretching of the cover 14 as the cover 14 is placed over the patio furniture 10 and the wheel assemblies 16 are placed over the distal ends of the legs 18. Alternatively, depending on the specific configuration of the patio furniture 10, the material of the cover 14 may have little elasticity, and the distal ends of the legs 18 may be inserted into the wheel assemblies 16 by the manner in which the cover 14 is placed over the patio furniture 10. By way of example, the cover 14 may be placed over the patio furniture 10 beginning with placing the distal ends of the legs 18 in the wheel assemblies 16, followed by placing the remainder of the cover 14 over the patio furniture 10 only after the legs 18 are in the wheel assemblies 16.

In some embodiments, as illustrated in FIGS. 3 and 4, the cover 14 may include a pocket or pouch, such as pouch 20. The pouch 20 may be attached to the cover 14 or may be formed as an integral part of the cover 14. The pouch 20 serves as a storage location for the cover 14. To use the pouch 20 for storage, the cover 14 may be removed from the patio furniture 10. The cover 14 may then be folded into the pouch 20 for compact storage when the cover 14 is not in use. The pouch 20 may be appropriately sized to receive the entire cover 14, including the wheel assemblies 16, or the cover 14 may be stored in the pouch 20 in such a way that the wheel assemblies 16 are located just outside the opening of the pouch 20.

As may be appreciated from FIGS. 3 and 4, and as is further illustrated by FIGS. 5-7, each of the wheel assemblies 16 includes a wheel 22 configured to contact the ground or other surface supporting the patio furniture 10. The wheel assemblies 16 also include a well 24 or cavity configured to receive the distal ends of the legs 18. In at least some embodiments, such as is illustrated in the Figures, the well 24 may have a shape wherein an upper portion 26 of the well 24 is broader (i.e. has a larger cross-sectional area) than a lower portion 28 of the well 24. The broad upper portion 26 permits some flexibility when inserting the legs 18 into the well 24, and eases and facilitates placement of the cover 14, while the narrower lower portion 28 better secures the distal ends of the legs 18 within the wheel assemblies 16.

As illustrated in the Figures, and particularly in FIGS. 5-7, an upper rim 30 of the well 24 may include a cutout 32 on one or more sides to further facilitate receiving of the legs 18 within the wells 24. The cutout 32 and the narrowing shape of the wells 24 assist in placement of the legs 18 within the wheel assemblies 16, and may also assist in removal of the wheel assemblies 16 from the legs 18. Those of skill in the art will readily appreciate the varying materials that may be used to construct the wheels 22 and the wells 24. Non-limiting examples of materials that may be used include durable plastics, metals including steel, aluminum, and brass, nylon, fiberglass, etc.

While the embodiments of the wheel assemblies 16 described above and shown in the Figures are representative of the features and advantages that may be obtained by the practice of the embodiments of the invention, other shapes of the wheel assemblies 16 may be advantageously used, and additional features may be added in some embodiments of the invention. By way of example, while the narrowing shape of the wells 24 described above may be helpful in placement of the legs 18 during covering of the patio furniture 10 and may also serve to allow the cover 14 to be used with differing types/brands of patio furniture 10, it is envisioned that the shape of the well 24 may be configured to snugly receive a particular piece/brand of patio furniture 10. This could reduce unwanted motion of the legs 18 within the wells 24 during handling of the covered patio furniture 10, improving stability of the wheels 22 during wheeled transportation of the covered patio furniture 10.

Alternatively, the wells 24 may be modified to include one or more tightening devices, such as a strap or an inner collar tightened by a strap. The wells 24 in this instance could have the large upper portion 26, and the tightening device could be accessible from the outside of the cover 14 (i.e. a portion could pass through a slot in either or both of the wells 24 and the material of the cover 14 to easily allow the tightening device to be tightened around the legs 18 of the patio furniture 10. The tightening device may include a buckle or cinching device to allow the tightening device to remain in its tightened state until released by the user. In this way, the wheel assemblies 16 could be snugly secured to varied sizes and shapes of legs 18, achieving the same stability effects of a custom-fitted well 24.

It will be appreciated that after applying an embodiment of the cover 14, as described above, to a selected piece of patio furniture 10, an individual may easily and readily move the patio furniture 10 using the wheeled features of the cover 14. This may be done by lifting a portion of the patio furniture 10 away from the wheel assemblies 16 until only the wheels 22 are touching the ground, and the individual may then readily roll the patio furniture 10 to a desired location.

For heavier pieces of patio furniture, the embodiments described above may be modified by the addition of additional wheel assemblies 16 to permit rolling of the covered patio furniture 10 without requiring that a user lift any portion of the patio furniture 10. By way of example, for a heavy table, four wheel assemblies 16 may be used on four corners/legs 18 of the table. For a table with three legs 18, three wheel assemblies 16 may be provided. In such instances, one or more of the wheels 22 of the wheel assemblies 16 may be made to swivel in any direction or may be replaced with casters or the equivalent, as will be readily understood by one of skill in the art. Additional wheel assemblies 16 may be provided for additional legs 18 of the patio furniture 10, depending on the weight, configuration of the patio furniture 10 to be covered.

Thus, embodiments of the invention may be utilized in conjunction with methods for providing a rolling patio furniture cover 14 for patio furniture 10, the methods including providing a cover 14 for patio furniture 10 having two or more wheel assemblies configured to receive legs 18 of the patio furniture 10. The methods may further include covering the patio furniture 10 with the cover 14, wherein covering the patio furniture 10 includes receiving legs 18 of the patio furniture 10 within the wheel assemblies and placing the cover 14 to cover the patio furniture 10. Optionally, covering the patio furniture 10 may include tightening a tightening device to further secure the legs 18 within the wheel assemblies 16. The methods may further include transporting the covered patio furniture 10 utilizing the wheels 22 of the wheel assemblies 16, which may include lifting an un-wheeled portion of the covered patio furniture 10. The methods may also include removing the cover 14 (which may include loosening the tightening device) and storing the cover 14 in the pouch 20.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A rolling patio furniture cover comprising:
a covering configured to receive and cover a piece of patio furniture, the covering being formed from a cover material; and
a pair of wheel assemblies, each wheel assembly being attached to the covering at a location corresponding to a leg of the patio furniture comprising:
a well configured to receive the leg of the patio furniture; and
a wheel rotatably connected to the well.

2. A cover as recited in claim 1, wherein the covering further comprises a pouch attached to the covering that is configured to receive and store the covering when the covering is not in use.

3. A cover as recited in claim 1, wherein the covering further comprises a pouch integrally formed with the covering that is configured to receive and store the covering when the covering is not in use.

4. A cover as recited in claim 1, wherein at least one of the wheel assemblies further comprises a tightening device to secure the associated wheel assembly to the leg received by the associated well.

5. A cover as recited in claim 4, wherein the tightening device comprises an inner collar.

6. A cover as recited in claim 5, wherein the tightening device further comprises a strap.

7. A cover as recited in claim 6, wherein the strap is accessible from outside the covering when the cover is on the patio furniture.

8. A cover as recited in claim 4, wherein at least a portion of the tightening device is accessible from outside the covering to permit tightening and loosening of the tightening device from outside the covering when the cover is covering the patio furniture.

9. A cover as recited in claim 1, wherein the well comprises:
a broad upper portion; and
a narrow lower portion.

10. A cover as recited in claim 9, wherein the well further comprises:
an upper rim; and
a cutout of the upper rim to facilitate placement of the leg within the well.

11. A cover as recited in claim 1, wherein the well comprises:
an upper rim; and
a cutout of the upper rim to facilitate placement of the leg within the well.

12. A cover as recited in claim 1, wherein the well is configured to snugly fit and receive the leg.

13. A cover as recited in claim 1, wherein the patio furniture is one of:
a chair;
a stack of chairs;
a lounge chair;
a table;
a bench;
a stool;
an outdoor grill;
a standalone bar;
a rocker chair;
a glider;
a porch swing;
a love seat;
a couch;
a sectional sofas;
a section of a sectional sofa;
a chaise;
a chaise lounges;
an ottomans;
an umbrella stand;
a hammock stands; and
a table/bench combinations.

14. A cover as recited in claim 1, further comprising additional wheel assemblies attached to the covering at locations corresponding to additional legs of the patio furniture.

15. A method for covering patio furniture with a rolling patio furniture cover comprising:
providing a rolling patio furniture cover comprising
a covering configured to receive and cover a piece of patio furniture, the covering being formed from a cover material; and
a pair of wheel assemblies, each wheel assembly being attached to the covering at a location corresponding to a leg of the patio furniture comprising:
a well configured to receive the leg of the patio furniture; and
a wheel rotatably connected to the well; and
covering the patio furniture with the cover, wherein covering the patio furniture comprises:
receiving the legs of the patio furniture within the wheel assemblies; and
placing the covering to cover the patio furniture.

16. A method as recited in claim 15, further comprising tightening a tightening device to secure at least one of the legs within at least one of the wheel assemblies.

17. A method as recited in claim 15, further comprising transporting the covered patio furniture utilizing wheels of the wheel assemblies.

18. A method as recited in claim 17, wherein transporting the covered patio furniture comprises lifting an un-wheeled portion of the covered patio furniture.

19. A method as recited in claim 15, further comprising removing the cover and storing the cover in a pouch integrally formed with the covering.

20. A method as recited in claim 15, further comprising removing the cover and storing the cover in a pouch attached to the covering.
